(19) United States
(12) Patent Application Publication
(10) Pub. No.: US 2013/0275440 A1
(43) Pub. Date: Oct. 17, 2013

(54) ARTICLE SELECTION

(71) Applicants: Sihem AMER-YAHIA, Doha (QA); Piotr INDYK, Cambridge, MA (US)

(72) Inventors: Sihem AMER-YAHIA, Doha (QA); Piotr INDYK, Cambridge, MA (US)

(73) Assignee: Qatar Foundation, Doha (QA)

(21) Appl. No.: 13/468,929

(22) Filed: May 10, 2012

(30) Foreign Application Priority Data
Apr. 12, 2012 (GB) 1206445.7

(51) Int. Cl. G06F 17/30

(52) U.S. Cl. 707/749; 707/E17.084

(57) ABSTRACT

A computer-implemented method for selecting an article from an input set of articles stored on a database of a source device, comprises generating a subset of the articles relevant to a query article using a relevance metric representing a measure of dissimilarity between the query article and selected articles in the set, computing distance measures for respective ones of the articles in the subset using article attributes and article commentary objects, using the distance measures to determine measures of the diversity of respective ones of articles in the subset from one another, and using the diversity measures to select a diverse article in the subset.

### CROSS-REFERENCE TO RELATED APPLICATIONS

This application claims foreign priority from UK Patent Application Serial No. 1206445.7, filed 12 Apr. 2012.

### BACKGROUND

News sources provide a collection of news articles around and based on various topics. For example, multiple online news websites exist that can provide news articles for users which can be browsed and organized by, amongst other things, a topic, editor, date, measure of importance or by a measure of popularity for example. Organisation is typically designed to allow a user to explore articles of interest and to therefore drive website traffic.

Typically, as well as news articles, user opinions and opinion articles can be a driver of traffic on a website. For example, user comments posted in connection with an article or topic can drive traffic to and from other areas of a website, such as to other news articles which may or may not be related. Comments tend to express a level of user agreement or disagreement with the content of an article, and recommendations can be provided to users based on a measure for the popularity of an article which takes into account the number of comments received or the number of shares for an article for example.

### SUMMARY

According to an example, there is provided a system and method which uses a measure of diversity for article recommendation, and in particular a measure of diversity which can provide a recommendation for an article in which sentiment for the article is generally polarized towards a level of agreement or disagreement with the article or content of the article for example. Polarization can be uniform, or can be in the form of some other distribution. For example, sentiment for an article could be broadly positive among users from Europe, negative in the Gulf, positive among the youth in the world, neutral among females and so on.

Accordingly, there is a departure from traditional recommendation systems in which the goal is to maximize accuracy and the number of positive votes, where, for example accuracy is computed according to a user profile (past purchasing habits, current browsing, search query, etc).

In the context of news for example, the result (a set of recommended articles) can be diversified based on a function that operates on sentiment expressed over those articles. In an example, such a function can be used to maximize positive sentiment or provide other sentiment distributions and for example, return articles for which the sentiment of people in the US differs from that of people in France and from that of males in a particular age range over a certain geographic area.

According to an example, multiple sentiment distributions for articles over user populations can be provided. Given an input or query article, an article can be recommended for a user from one or more sets of articles which are determined as relevant to the query article and are present in one or more of the sentiment distributions, thereby providing a user with an article which is relevant to the query but diverse according to some predetermined measure.

According to an example, there is provided a computer-implemented method for selecting an article from an input set of articles stored on a database of a source device, comprising generating a subset of the articles relevant to a query article using a relevance metric representing a measure of dissimilarity between the query article and selected articles in the set, computing distance measures for respective ones of the articles in the subset using article attributes and article commentary objects, using the distance measures to determine measures of the diversity of respective ones of articles in the subset from one another, and using the diversity measures to select a diverse article in the subset.

In such an example, generating a subset of the articles includes providing a threshold relevance radius such that all articles relevant to the query article are those which are within the relevance radius from the query article.

Selecting a diverse article in the subset may include selecting an article from a set of articles within the relevance radius for a query article which maximise their pairwise diversity according to a diversity distance.

In one example, the diversity distance is a measure which is the maximum over the set of articles in the subset of the minimum pairwise distance between the articles.

Generating a subset of articles may include hashing data representing articles to provide hashed articles and using the hashed articles to map similar articles to the hash tables according to a measure representing the probability that the articles are similar.

Determining measures of the diversity of respective ones of articles in the subset may include generating respective sets of articles from those within the subset to form a sentiment distribution for articles.

In one example, the sentiment distribution is a distribution over multiple user populations which include sets of users parameterized according to their features.

A user population may be a characterization of a portion of an audience for an article or set of articles.

### BRIEF DESCRIPTION OF THE DRAWINGS

An embodiment of the invention will now be described, by way of example only, and with reference to the accompanying drawings, in which:

FIG. 1 is a schematic block diagram of a system according to an example; and

FIG. 2 is a schematic block diagram of a method according to an example.

### DETAILED DESCRIPTION

It will be understood that, although the terms first, second, etc. may be used herein to describe various elements, these elements should not be limited by these terms. These terms are only used to distinguish one element from another. The terminology used herein is for the purpose of describing particular examples only and is not intended to be limiting. As used herein, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Typically, user interest in articles and documents can be sparked by content with which there is a level of agreement or disagreement amongst users of the content—either with the content itself, or any commentary that may be provided with or for the content. Broadly, sentiment for certain articles can be characterized according to the nature of comments received for the articles, and can for example be distributed between a majority agreement or disagreement. In addition, sentiment distribution can be uneven amongst different user populations, where a population is any set of users that is parameterized according to their features, such as their location, sex, age and so on, and which is therefore a characterization of a portion of an audience for an article or set of articles.

When there is a broad disagreement with respect to the content of an article, such as a disagreement which can be articulated in the form of commentary for example, the article in question can prove interesting for a user since there is a negative polarization of sentiment towards the article thereby implying that the user may develop a strong reaction towards the article and its content, irrespective of the polarity of that reaction. Similarly, when there is a broad agreement with respect to the content of an article, the article in question can also prove interesting for a user since there is a positive polarization of sentiment towards the article thereby implying that the user may similarly develop a strong reaction. In an example, commentary includes comments as well as other objects which allow a user to express an opinion or sentiment, such a blog or microblog posting, a “share” or “like” for example.

Typically, user-generated content which is used to determine a measure for sentiment comes in the form of commentary on articles, which can include direct and indirect commentary—direct can include commentary which is provided in respect of an article and which may be directly linked to the article such as a comment or object immediately associated with the article, such as following an article for example, whereas indirect commentary can include blog, microblog or social media postings mentioning or referencing articles for example.

According to an example, given a query article or document which can be automatically selected, provided or otherwise indicated or used by a user, a system and method determines a set of relevant but diverse articles for the user. Diversity is a measure which indicates how different two articles are in the sense that article attributes and sentiment are used to determine diversity in a set of articles generated in response to a query.

The generalization is that a user may be more interested in a collection of articles that certain populations disagree on with possible agreement amongst other populations for example, and/or a collection of articles that certain populations agree on with possible disagreement amongst other populations for example. Accordingly, a system and method in an example, takes account of sentiments and their distribution in selecting articles for a user to read and potentially, comment on.

While positive sentiment is highly favored in recommending other content items (such as products and movies for example), in the case of news articles, a different sentiment distribution may be used to drive user attention and engagement, which sentiment distribution can be broadly categorized to segment a set of articles into a subset in which a compromise between relevance and sentiment diversity is leveraged in order to recommend an article for a user given an input query article. If there is optimization for relevance-only (meaning for accuracy-only), the most diverse set of articles in terms of their sentiment may not be obtained. Accordingly, there is a compromise, which provides a balance between relevance and diversity.

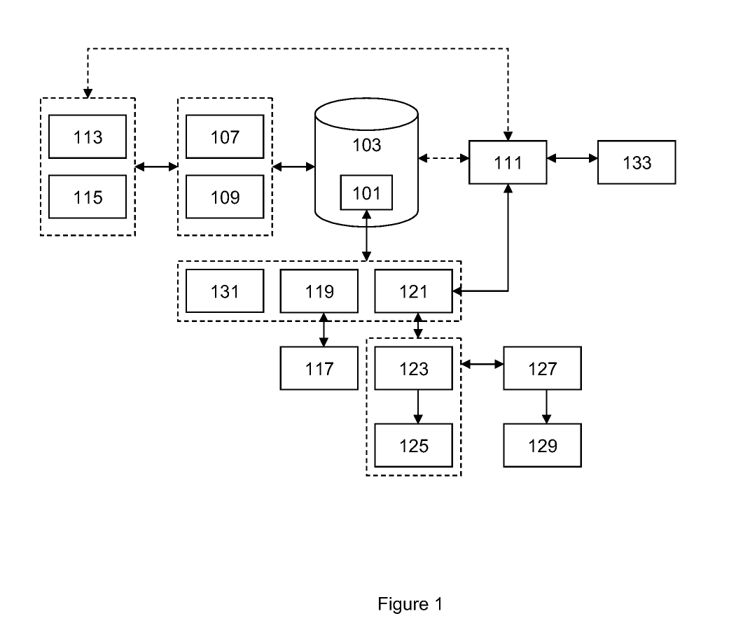

FIG. 1 is a schematic block diagram of a system according to an example. A set of articles 101 is provided on a database 103. Database 103 can be stored on a device such as a computing apparatus 107 or cloud based storage system 109 for example either of which are accessible to multiple users 111. In an example, articles 101 are articles including content based on topics related to news items, such as news items presented from a news website or other suitable dissemination source which can be accessed by users 111. Access can be via a web browser 113 which can include a mobile or smart device 115 specific browser for example.

In an example, each article 101 from the set of articles has an associated identifier 117 forming a set of identifiers 119 as well as a set of users 121 from the users 111 who have posted an article commentary object 123 on an article. An article commentary object 123 can be a comment 125 of the form [aid, u, text], where aid is the article identifier, u is the user who posted or otherwise provided the comment, and text is the wording of the comment. An article commentary object 123 can further include an expression of user sentiment, agreement or disagreement with an article which can be a simple vote or “like/dislike” indication for example.

A sentiment extraction module 127 can extract a measure 129 for the sentiment of a user article commentary object 123. For example, sentiment can be extracted in the case where a simple user expression is provided in as much as a “like” vote for example can indicate a positive user sentiment—that is a user sentiment which is positive in respect of the article or topic related to the user expression. Similarly, a “dislike” vote can indicate negative sentiment towards an article or topic. In the case of a commentary object which includes more substantial content such as a text string for example, sentiment can be extracted using techniques which map words in the string to a dictionary of words which include a sentiment measure associated with the word. For example, a measure for sentiment can include a triple [pos, neg, poll where pos indicates how positive the comment is, neg indicates its negativity, and pol measures its polarization. In an example, polarization can be determined by comparing positive and negative measures, such that, for example, a relatively higher value for positive than negative indicates a polarisation towards positive sentiment. In an example, values in the triple can be normalized and belong to [0,1].

An article 101 can also be characterized by a set of attributes 131 such as its topic, its date, its authors, its length, and its nature (e.g., opinion article, survey). Similarly, a user can carry demographics information 133 such as geographic location, gender, age, occupation, etc.

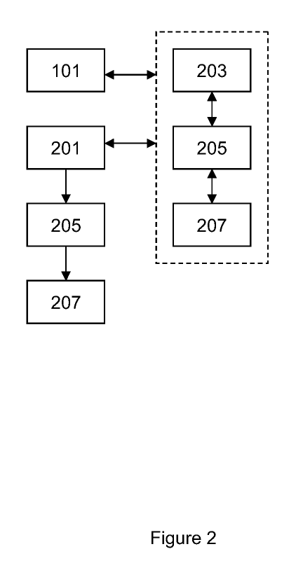

FIG. 2 is a schematic block diagram of a method according to an example. A subset 201 of articles 101 is generated with reference to a query article 203. In an example, a query article 203 can be an article which a user is currently viewing or which the user otherwise indicates as a query article. That is, a query article 203 can be used in a passive or active basis—passively, a user need not take any action for an article to be selected as a query article. Actively, a user can select or otherwise provide an indication of an article to form the basis of a query article 203, such as an article they are interested in reading for example, or an article which they believe could form the basis of a good query article.

In an example, the subset 201 of articles is generated with reference to the query article 203 using a relevance metric 205 which represents a measure of dissimilarity (or similarity) 207 between the query article 203 and articles in the set 101. Relevance metric 205 is a distance which determines the dissimilarity between the query article 203 and articles in the set 101, and is used to determine a set of articles relevant to a query article 203. In an example, given a query article 203 and a threshold radius r, the subset of articles 201 relevant to the query article 203 is defined as the set of all articles within relevance distance r from article 203. For example, a subset can be generated using the distance between two articles when represented by normalized word frequency vectors x and y such that the distance measure is 1−x.y. That is, x and y can be vectors of word frequencies in two articles. A common way of comparing two vectors such as those described above is using the cosine similarity to determine how similar the two articles are. Other suitable distance measures can be used.

Accordingly, subset 201 represents a collection of articles from the corpus 101 which have a relevance measure which is within a predetermined threshold with respect to the query article 203. It therefore includes articles which are considered to be relevant to the query article 203, which can include articles which are related and articles which can be categorised as belonging to the same topic family for example. In an example, articles can be relevant and therefore part of subset 201 but not directly or intuitively related.

According to an example, given a subset 201 of relevant articles in relation to an input query article 203, one or more articles from the subset 201 can be provided to a user based on a metric which represents diversity of articles in the subset of articles 201. Diversity distance determines how “different” two articles are, and can be used to determine the level of diversity of a set of answers to a query (typically the more diverse, the better).

In an example, diversity distance is induced using two distance functions for articles: attribute-based distance, Adist, and comment-based distance, Cdist. That is, in order to compute a diversity metric, a distance measure for articles in the subset 201 representing a similarity metric for the articles based on article attributes and article commentary objects is computed.

In block 205 the distance between two articles in the subset 201 is computed. In an example, the distance between two articles dist(aᵢ, aⱼ) is a function of the distance between their attributes and their comments, and is defined as:

dist(aᵢ,aⱼ)=α·Adist(aᵢ,aⱼ)+(1−α)·Cdist(aᵢ,aⱼ)

where α is a parameter in an example which is a float between 0 and 1 and is used to control the importance or relative weight of Adist and Cdist in the above formula. For example, if alpha is equal to 1, only Adist is used. In an example, the value of the parameter α can be set by an application developer or learned from user behaviour using classical machine learning methods for example.

There are different alternative attribute-based and comment-based distances which can be used. Comment-based distance can be defined as the Jaccard distance between the set of user identifiers associated to each article. It could also be defined as a function of agreement between users on the two articles.

According to an example, a measure for diversity 207 is thus a pairwise measure which can be parameterised by a value k representing a number of articles from subset 201. This is equivalent to determining the k most distinct (as measured by the diversity distance) articles from a set S (such as subset 201) in order to provide a selection of k diverse articles for a set C.

The pairwise k-diversity can be defined according to an example, as:

$${max}_{C ⋐ S} {min}_{{a}_{i} , {a}_{j} ∈ C} dist ( {a}_{i} , {a}_{j} )$$

where |C|=k. In the above formulation the diversity is thus defined as the maximum over any set of k articles of the minimum pairwise distance between those articles.

In block 209 a set C of the k most diverse articles among those whose relevance distance to the query q is at most r, i.e. those from subset 201 is selected. Accordingly, for a distance r and given a query point q in the form of the query article, a set of k points within distance r from q (according to the relevance distance) is determined that maximizes their pairwise k-diversity (according to the diversity distance).

In an example, an approximation where the goal is to find a set of k points that d-approximates their pairwise k-diversity (that is the k-diversity is at least 1/d times the best possible) can be used. Alternatively, a bi-criterion approximate version can be used, where for approximation factors c and d, a goal is to find a set of k points C, within distance cr from q such that the diversity within C is ≧1/d·div(S) where div(S) is the diversity in the set of points within distance r from q.

This can be solved (for c=1 and d=2 for example) by determining the set S of all points within relevance distance r from q, and 2-approximating div(S). The latter task can typically be performed using a 2-approximate Gonzales algorithm for example, such as describe in TF Gonzalez, “Clustering to minimize the maximum intercluster distance”, Theoretical Computer Science, 1985, the contents of which are incorporated herein by reference.

In some circumstances, the time taken to perform the above can be too long in some applications. Therefore, according to an example, multiple locality-sensitive hash functions can be used.

Formally, if B(q, r) is the set of all points within a relevance distance of r from a query article, q, a locally sensitive hashing process attempts to find all points in B(q, r) by creating L hash functions as well as corresponding hash arrays Then, each article p is stored in a bucket gᵢ(p) of Ai for all i=1 . . . L. The hash functions have the property that, for any q

B(q,r)⊂A₁(g₁(q))∪ . . . ∪A_{L}(g₁(q))

Therefore, for any query q, all points in A₁(g₁(q)) . . . A_{L}(g₁(q)) are recovered, and those that belong to Bᵣ(q) are retained.

In an example, locality-sensitive hashing (LSH) can be adapted to determine diversity. In order to determine the k most diverse points within distance r from q, for each bucket A[j]: the set A′[j] of k points that (d-approximately) maximize the diversity of A[j] is computed and stored. Then the process enumerates (at most Lk) points stored in buckets A′(gᵢ(q)), i=1 . . . L and returns the k most diverse points among those.

Holistic diversity is a generalization of pairwise diversity to operate on sets of articles of any size and could be used to return sets of articles on which the US population agrees or disagrees or those on which people in France disagree with the rest of Europe.

What is claimed is:

1. A computer-implemented method for selecting an article from an input set of articles stored on a database of a source device, comprising:
generating a subset of the articles relevant to a query article using a relevance metric representing a measure of dissimilarity between the query article and selected articles in the set;
computing distance measures for respective ones of the articles in the subset using article attributes and article commentary objects;
using the distance measures to determine measures of the diversity of respective ones of articles in the subset from one another; and
using the diversity measures to select a diverse article in the subset.

2. A computer-implemented method as claimed in claim 1, wherein generating a subset of the articles includes providing a threshold relevance radius such that all articles relevant to the query article are those which are within the relevance radius from the query article.

3. A computer-implemented method as claimed in claim 2, wherein selecting a diverse article in the subset includes selecting an article from a set of articles within the relevance radius for a query article which maximise their pairwise diversity according to a diversity distance.

4. A computer-implemented method as claimed in claim 3, wherein the diversity distance is a measure which is the maximum over the set of articles in the subset of the minimum pairwise distance between the articles.

5. A computer-implemented method as claimed in claim 1, wherein generating a subset of articles includes hashing data representing articles to provide hashed articles and using the hashed articles to map similar articles to the hash tables according to a measure representing the probability that the articles are similar.

6. A computer-implemented method as claimed in claim 1, wherein determining measures of the diversity of respective ones of articles in the subset includes generating respective sets of articles from those within the subset to form a sentiment distribution for articles.

7. A computer-implemented method as claimed in claim 6, wherein the sentiment distribution is a distribution over multiple user populations which include sets of users parameterized according to their features.

8. A computer-implemented method as claimed in claim 7, wherein a user population is a characterization of a portion of an audience for an article or set of articles.
